(19) United States
(12) Patent Application Publication
(10) Pub. No.: US 2015/0106177 A1
(43) Pub. Date: Apr. 16, 2015

(54) SYSTEM AND METHOD FOR ENABLING A REFERRAL OF A PRODUCT

(71) Applicant: Aaron Woolf, Essendon (AU)

(72) Inventor: Aaron Woolf, Essendon (AU)

(21) Appl. No.: 14/395,054

(22) PCT Filed: Apr. 17, 2014
(86) PCT No.: PCT/AU2013/000398

§ 371 Date: Oct. 16, 2014

(30) Foreign Application Priority Data
Apr. 19, 2012 (AU) 2012901544
Apr. 10, 2013 (AU) 2013203504

(51) Int. Cl. G06Q 30/02

(52) U.S. Cl. CPC G06Q 30/0214
USPC 705/14.16

(57) ABSTRACT

A system for enabling a referral of a product, comprising: a retriever for retrieving from a database a product identifier; a generator for generating product referral data with respect to an external system using the retrieved product identifier, wherein the generated product referral data is retrievable by a first device in communication with the external system, the product referral data once retrieved being for addition to an external database in communication with the external system, by accessing the external system using a nominated user identifier of a user, and the product referral data once added to the external database is retrievable by a second device in communication with the external system, the product referral data once retrieved by the second device being for generation of user identification data corresponding to the nominated user identifier; and a receiver for receiving the user identification data and making an award to the user.

### RELATED APPLICATIONS

This application claims the benefit of the priority of Australian Provisional Application No. 2012901544, the content of which as filed is incorporated by reference in its entirety. This application also claims the benefit of the priority of Australian Standard Application No. 2013203504, the content of which as filed is incorporated by reference in its entirety.

### FIELD

The invention relates to a system and method for enabling a referral of a product.

### BACKGROUND

Facebook (trade mark) is an online social networking website (see www.facebook.com). Through Facebook, users can share with other users content such as status updates, comments, links, advertisements etc. A webpage that is not part of Facebook can incorporate software components called plugins or addons to enable Facebook users to share content from the webpage with other Facebook users. An example of a plugin is the “Like Button” plugin provided by Facebook. This plugin allows a Facebook user to “like” or refer content from a non-Facebook webpage to other Facebook users by clicking on a “Like Button”.

There is a need for alternative or improved features.

### SUMMARY OF INVENTION

In a first aspect, the invention provides a system for enabling a referral of a product, comprising:

a product identifier retriever arranged to retrieve from a product database a product identifier of a product;

a product referral data generator arranged to generate product referral data with respect to an external computing system using the retrieved product identifier, wherein
(i) the generated product referral data is for retrieval by a first user computing device in data communication with the external computing system, the product referral data once retrieved by the first user computing device being for addition to an external database in data communication with the external computing system, by accessing the external computing system using a nominated user identifier of a user, and
(ii) the product referral data once added to the external database is for retrieval by a second user computing device in data communication with the external computing system, the product referral data once retrieved by the second user computing device being for generation of user identification data corresponding to the nominated user identifier; and

a user identification data receiver arranged to:
receive the user identification data corresponding to the nominated user identifier; and
make an award to the user corresponding to the nominated user identifier.

In an embodiment, the first user computing device and the second user computing device are provided by the same computing device.

In an embodiment, the product referral data once added to the external database enables a message to be generated on a website provided by the external computing system.

In an embodiment, the message comprises a link to a retail website provided by a retail computing system.

In an embodiment, the message comprises a user tracking link for enabling the generation of the user identification data.

In an embodiment, the received user identification data is received from the second user computing device upon a user following the user tracking link using the second user computing device.

In an embodiment, the received user identification data is received from the retail computing device upon a user following a link to a purchase webpage of the retail website.

In an embodiment, the award corresponds to an award value corresponding to the product.

In an embodiment, a user counter is incremented in response to receipt of the user identification data.

In an embodiment, the user counter is stored in a user database.

In an embodiment, the user identification data receiver is arranged to monitor the user counter.

In an embodiment, the user identification data receiver is arranged to make the award in response to the user counter reaching a predetermined value.

In a second aspect, the invention provides a computer-implemented method of enabling a referral of a product, comprising:

retrieving from a product database a product identifier of a product;

generating product referral data with respect to an external computing system using the retrieved product identifier, wherein
(i) the generated product referral data is for retrieval by a first user computing device in data communication with the external computing system, the product referral data once retrieved by the first user computing device being for addition to an external database in data communication with the external computing system, by accessing the external computing system using a nominated user identifier of a user, and
(ii) the product referral data once added to the external database is for retrieval by a second user computing device in data communication with the external computing system, the product referral data once retrieved by the second user computing device being for generation of user identification data corresponding to the nominated user identifier; and

receiving the user identification data corresponding to the nominated user identifier; and

making an award to the user corresponding to the nominated user identifier.

In an embodiment, the first user computing device and the second user computing device are provided by the same computing device.

In an embodiment, the product referral data once added to the external database enables a message to be generated on a website provided by the external computing system.

In an embodiment, the message comprises a link to a retail website provided by a retail computing system.

In an embodiment, the message comprises a user tracking link for enabling the generation of the user identification data.

In an embodiment, the received user identification data is received from the second user computing device upon a user following the user tracking link using the second user computing device.

In an embodiment, the received user identification data is received from the retail computing device upon a user following a link to a purchase webpage of the retail website.

In an embodiment, the award corresponds to an award value corresponding to the product.

In an embodiment, the method further comprises incrementing a user counter in response to receipt of the user identification data.

In an embodiment, the user counter is stored in a user database.

In an embodiment, the method further comprises monitoring the user counter.

In an embodiment, the award is made in response to the user counter reaching a predetermined value.

In a third aspect, the invention provides a system for enabling a referral of a product, comprising:

a product identifier retriever arranged to retrieve from a product database a product identifier of a product available for purchase on a retail website provided by a retail computing system;

a product referral data generator arranged to generate product referral data with respect to an external computing system using the retrieved product identifier, wherein
(i) the generated product referral data is for retrieval by a first user computing device in data communication with the external computing system, the product referral data once retrieved by the first user computing device being for addition to an external database in data communication with the external computing system, by accessing the external computing system using a nominated user identifier of a user,
(ii) the product referral data once added to the external database is for generation of message data for retrieval by a second user computing device in data communication with the external computing system and the retail computing system, the message data once retrieved by the second user computing device being for generation of a message comprising a user tracking link for generating user identification data corresponding to the nominated user identifier, and
(iii) the user identification data once generated by the second computing device being for transmission from the second user computing device to the system or the retail computing system; and

a user identification data receiver arranged to:
receive from the second user computing device or the retail computing system the user identification data corresponding to the nominated user identifier; and
make an award to the user corresponding to the nominated user identifier.

In a fourth aspect, the invention provides a system for enabling a referral of a product, comprising:

a product identifier receiver arranged to receive a product identifier of the product from a retail computing system;

a user identifier receiver arranged to receive a user identifier for accessing a user database storing a plurality of external user identifiers, each external user identifier being associated with a respective one of a plurality of user identifiers in the user database;

an external user identifier retriever arranged to retrieve one or more external user identifiers from the user database using the received user identifier;

a product referral data generator arranged to generate product referral data with respect to each one of one or more external computing systems in data communication with respective external databases, using the received product identifier; and

a product referral adder arranged to access the external computing systems using respective retrieved external user identifiers to add the generated product referral data to respective external databases of the external computing systems.

In an embodiment, the product is a good, a service, or a good and a service.

In an embodiment, the product identifier comprises a retailer identifier and an award value.

In an embodiment, the retail computing system is or provides a retail website.

In an embodiment, the product identifier is transmitted from the retail computing system to the product identifier receiver upon a user following a link on the retail website.

In an embodiment, the product referral data comprises product data retrieved by a product data retriever from a product database using the received product identifier.

In an embodiment, the product data comprises a description of the product and a product price.

In an embodiment, the product data comprises a link to the retail website.

In an embodiment, each external computing system is or provides a social networking website, and each retrieved external user identifier is a social networking website username for accessing the social networking website provided by the external computing system.

In an embodiment, the product referral data enables a message to be generated on the social networking website provided by the external computing system.

In an embodiment, the message comprises the link to the retail website of the product data.

In an embodiment, the message comprises a user tracking link comprising user identification data for identifying the received user identifier.

In an embodiment, the user identification data is arranged to be transmitted to the system upon a user following the user tracking link.

In an embodiment, the user identification data is arranged to be transmitted to the system upon a user following a link to a purchase webpage of the retail website.

In an embodiment, the system further comprises a user identification data receiver arranged to receive the user identification data transmitted to the system.

In an embodiment, the user identification data receiver is arranged to make an award in response to receiving the transmitted user identification data.

In an embodiment, the award corresponds to the award value.

In an embodiment, the user identification data receiver is arranged to increment a user counter in response to receiving the transmitted user identification data.

In an embodiment, the user counter is stored in the user database.

In an embodiment, the user identification data receiver is arranged to monitor the user counter.

In an embodiment, the user identification data receiver is arranged to make an award in response to the user counter reaching a predetermined value.

In an embodiment, the user identifier is received by the user identifier receiver from a first user device and the user identification data is received by the user identification data receiver from a second user device.

In an embodiment, the system further comprises the user database.

In an embodiment, the system further comprises the product database.

In a fifth aspect, the invention provides a computer-implemented method of enabling a referral of a product, comprising:

receiving a product identifier of the product from a retail computing system;

receiving a user identifier for accessing a user database storing a plurality of external user identifiers, each external user identifier being associated with a respective one of a plurality of user identifiers in the user database;

retrieving one or more external user identifiers from the user database using the received user identifier;

generating product referral data with respect to each one of one or more external computing systems in data communication with respective external databases, each product referral data corresponding to the received product identifier; and

accessing the external computing systems using respective retrieved external user identifiers to add respective product referral data to respective external databases of the external computing systems.

In an embodiment, the product is a good, a service, or a good and a service.

In an embodiment, the product identifier comprises a retailer identifier and an award value.

In an embodiment, the retail computing system is or provides a retail website.

In an embodiment, the product identifier is transmitted from the retail computing system to the product identifier receiver upon a user following a link on the retail website.

In an embodiment, the product referral data comprises product data retrieved by a product data retriever from a product database using the received product identifier.

In an embodiment, the product data comprises a description of the product and a product price.

In an embodiment, the product data comprises a link to the retail website.

In an embodiment, each external computing system is or provides a social networking website, and each retrieved external user identifier is a social networking website username for accessing the social networking website provided by the external computing system.

In an embodiment, the product referral data enables a message to be generated on the social networking website provided by the external computing system.

In an embodiment, the message comprises the link to the retail website of the product data.

In an embodiment, the message comprises a user tracking link for enabling generation of user identification data for identifying the received user identifier.

In an embodiment, the user identification data is arranged to be transmitted to the system upon a user following the user tracking link.

In an embodiment, the user identification data is arranged to be transmitted to the system upon a user following a link to a purchase webpage of the retail website.

In an embodiment, the method further comprises:

receiving user identification data transmitted in response to a user following a link of a message generated using the product referral data added to one of the external databases; and

making an award in response to receiving the user identification data.

In an embodiment, the award corresponds to the award value.

In an embodiment, the method further comprises incrementing a user counter in response to receiving the transmitted user identification data.

In an embodiment, the user counter is stored in the user database.

In an embodiment, the user identification data receiver is arranged to monitor the user counter.

In an embodiment, the user identification data receiver is arranged to make an award in response to the user counter reaching a predetermined value.

In an embodiment, the user identifier is received by the user identifier receiver from a first user device and the user identification data is received by the user identification data receiver from a second user device.

### BRIEF DESCRIPTION OF THE DRAWINGS

In order that the invention may be more clearly ascertained, embodiments will now be described, by way of example, with reference to the accompanying drawings, in which:

FIG. 1 is a schematic diagram of the physical architecture of an embodiment of the system for enabling a referral of a product;

FIG. 2 is a schematic diagram of the functional components of the system of FIG. 1;

FIG. 3 is a flow chart of an embodiment of the method of enabling a referral of a product, carried out using the system of FIGS. 1 and 2;

FIG. 4 is a schematic diagram of the physical architecture of another embodiment of the system for enabling a referral of a product;

FIG. 5 is a schematic diagram of the functional components of the system of FIG. 4; and

FIG. 6 is a flow chart of another embodiment of the method of enabling a referral of a product, carried out using the system of FIGS. 4 and 5.

### DETAILED DESCRIPTION

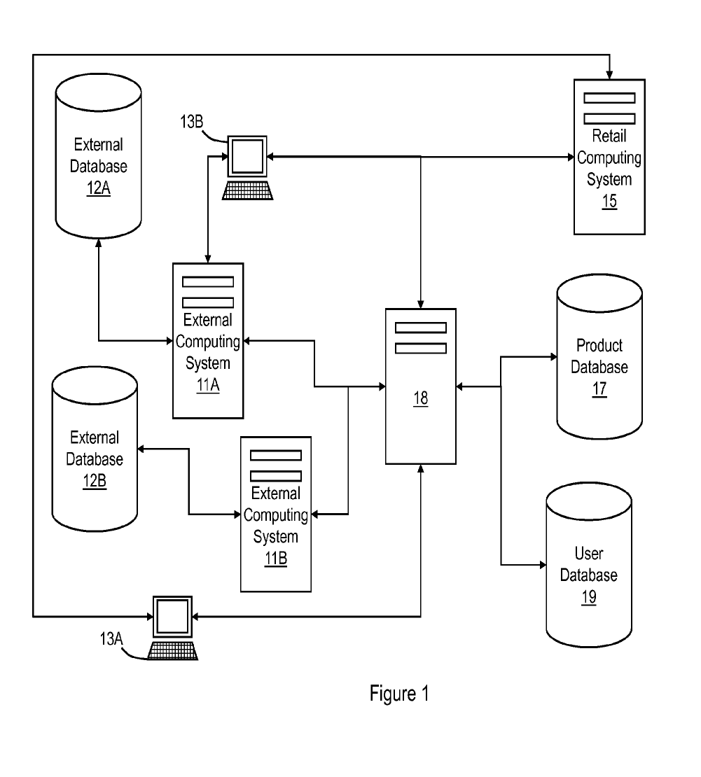

Referring to FIGS. 1 to 3 of the drawings, there is shown an embodiment of a system for enabling a referral of a product (such as a good, a service, or a good and a service). The system is arranged to generate product referral data with respect to a product and to add the product referral data to one or more external databases. Advantageously, the system enables a user to refer a product to one or more users of one or more external computing systems automatically without requiring the user to manually access the one or more external computing systems. A further advantage is that the system enables positive outcomes of such referrals to be tracked.

It is envisaged that the system is typically implemented by a computing device in data communication with a plurality of other computing devices. Examples of such a computing device include a computer server, a desktop personal computer, a portable computer (such as a laptop computer, a notebook computer or a tablet computer), a mobile computing device (such as a smartphone), a programmable circuit etc. Persons skilled in the art will appreciate that the system may be implemented by multiple computing devices such that each computing device implements only a part or parts of the system.

FIG. 1 is a schematic diagram of the physical architecture of an embodiment of the system 18. The system 18 is connected to a retail computing system 15. The retail computing system 15 provides a retail website. Products are available for purchase on the retail website. The system 18 is also connected to a first external computing system 11A providing a social networking service and website Facebook, and a second external computing system 11B providing a second social networking and blogging service and website Twitter (trade mark) (see www.twitter.com). The external computing system 11A is connected to an external database 12A storing data of users of Facebook. The external computing system 11B is connected to an external database 12B storing data of users of Twitter. It is envisaged that the system 18 may be connected to only one external computing system or to more than two external computing systems. Persons skilled in the art will appreciate that the system may be connected to an external computing system that does not provide a social networking service or a blogging service. For example, the system may be connected to an external computing system providing personal user websites.

A first user computing device 13A is connected the system 18 and the retail computing system 15. A user of the system 18 can access the system 18 using the first user computing device 13A by using a user identifier. It is envisaged that the user identifier is in the form of a username and password, but persons skilled in the art will appreciate that the user identifier may be in another form such as a security code, a barcode read by a barcode reader or a number identifying the user such as a mobile phone number.

The system 18 is connected to a user database 19 storing a plurality of external user identifiers, each user identifier being associated with one of a plurality of user identifiers in the user database 19. In this example, each one of the external user identifiers stored in the user database 19 is either a Facebook username and a Facebook password corresponding to the Facebook username, or a Twitter username and a Twitter password corresponding to the Twitter username. The system can access the first external computing system 11A—that is, Facebook—by first logging into the first external computing system 11A using an external user identifier—such as a Facebook username and a Facebook password corresponding to the Facebook username—associated with the user identifier of the system 18 stored in the user database 19. Similarly, the system can access the second external computing system 12A—that is, Twitter—by first logging into the second external computing system 11B using an external user identifier—such as a Twitter username and a Twitter password corresponding to the Twitter username—associated with the user identifier of the system 18 stored in the user database 19.

The system 18 is connected to a product database 17 storing product data with respect to each one of the products available for purchase on the retail website provided by the retail computing system 15. The product data with respect to a product is added to the product database 17 by the retailer making the product available for purchase on the retail website.

A second user computing device 13B is connected to the first external computing system 11A and the retail computing system 15. A user of Facebook (a Facebook friend) can access the first external computing system 11A using the second user computing device 13B by inputting a Facebook username and a Facebook password corresponding to the Facebook username. In this example, the Facebook friend is linked to the user of the system 18 such that messages—such as status updates, comments, photos, links etc—added by the user of the system 18 to Facebook can be viewed by the Facebook friend.

Persons skilled in the art will appreciate that the product database 17 and the user database 19 may be implemented in a single storage device or in separate storage devices.

The system 18 comprises a number of functional components for enabling a referral of a product. It is envisaged that the functional components are typically implemented by a processor of the system 18 executing program code and data stored in a memory of the system 18. However, persons skilled in the art will appreciate that this need not be the case. For example, one or more of the components could be implemented in an alternative manner, for example, as a dedicated circuit.

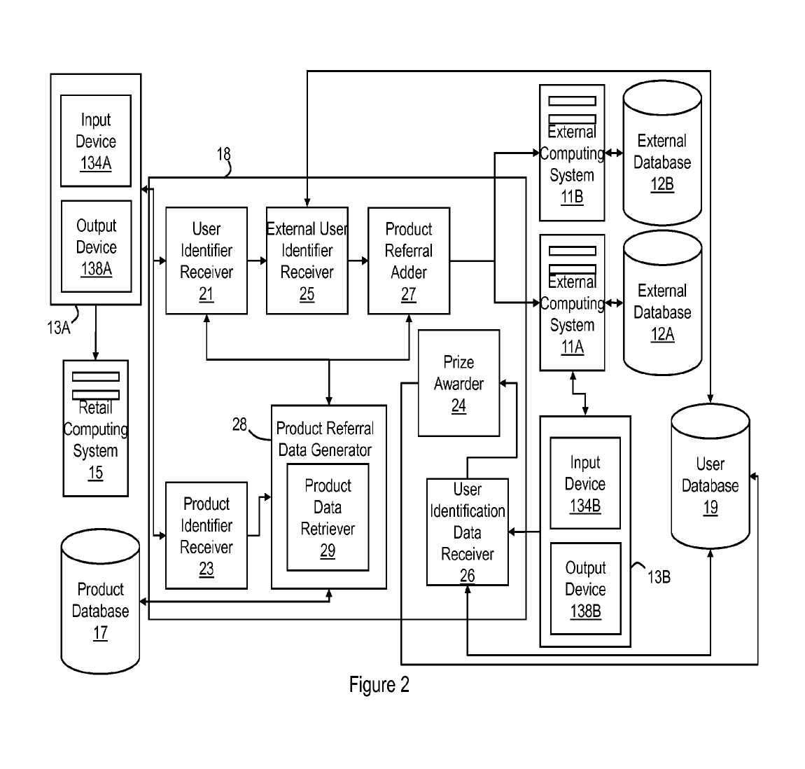

FIG. 2 is a schematic diagram showing the functional components of the system 18. One of the components is a product identifier receiver 23 arranged to receive a product identifier of a product from the retail computing system 15. As discussed above, a plurality of products are available for purchase on the retail website provided by the retail computing system 15. A button is provided on the retail website for each of the products on the retail website. An award value corresponding to a product is displayed on the button for the product. The award value may be equivalent to a percentage value of the price of the product. A program script written in JavaScript (trade mark) is executed when a user operating the user computing device 13A clicks on a button with respect to a product on the retail website. An example of the program script is provided below.
<a href=“https://system.com/myer?company=5543proId=8434392?price=<?php echo $price; ?>”
class=“system-button”>$3 REFER</a>
<script>!function(d,s,id){var
js,fjs=d.getElementsByTagName(s)[0];if(!d.getElementById(id)){js=d.
createElement(s);js.id=id;js.src=“//code.system.com/widgets.js”;fjs.parentNode.insert
Before(js,fjs);}}
(document,“script”,“system-js”);</script>

Persons skilled in the art will appreciate that graphic user interface (GUI) elements other than buttons may be provided in place of the buttons with respect to the products on the retail website. Persons skilled in the art will also appreciate that text may be provided in place of the buttons with respect to the products on the retail website.

A querystring including the product identifier of the product is transmitted from the user computing device 13A to the system 18 when the program script is executed. It is envisaged that the querystring may include other data such as a retailer identifier for identifying the retail computing device 15 or the retail website, the product price, the award value etc. Also, it is envisaged that the retailer identifier may be derived from the product identifier. For example, the product identifier may be an alphanumeric sequence and the retailer identifier may be a sub-sequence within the alphanumeric sequence. In an embodiment, the programming code implementing the buttons on the retail website is generated by the system 18 and added to the programming code of the retail website. However, persons skilled in the art will appreciate that the programming code implementing the buttons may be generated in another way.

Another one of the components of the system 18 is a user identifier receiver 21 arranged to receive a user identifier. It is envisaged that the user identifier may be input by the user using the user computer device 13A or stored in a memory of the user computing device 13A before the user identifier is transmitted to the user identifier receiver 21. For example, the user identifier may be input by the user using the user computer device 13A in response to a pop-up windows appearing on a display of the user computer device 13A requesting the user to input the user identifier after a button with respect to a product on the retail website is clicked by the user. In another example, the user identifier may be stored by an application (such as a web browser) in a memory of the user computing device 13A, and the user identifier may be automatically transmitted from the user computing device 13A to the system 18 (and hence the user identifier receiver 21) after a button with respect to a product on the retail website is clicked by the user. The user identifier is transmitted together with the product identifier in the querystring from the user computer device 13A to the system 18 when the JavaScript is executed.

The system 18 comprises an external user identifier retriever 25 arranged to retrieve one or more external user identifiers (that is, a Facebook username and a Facebook password corresponding to the Facebook username, a Twitter username and a Twitter password corresponding to the Twitter username, or a Facebook username and a Facebook password corresponding to the Facebook username and a Twitter username and a Twitter password corresponding to the Twitter username) associated with the user identifier received by the user identifier receiver 21. The external user identifier retriever 25 automatically retrieves the external user identifiers upon the user identifier receiver 21 receiving the user identifier, by locating from the plurality of external user identifiers stored in the user database 19 external user identifiers associated with the user identifier received by the user identifier receiver 21.

The system 18 also comprises a product referral data generator 28 arranged to generate product referral data with respect to each one of the first external computing system 11A and the second external computing system 11B using the product identifier received by the product identifier receiver 23. The product referral data generator 28 automatically generates the product referral data upon the product identifier receiver 23 receiving the product identifier. The product referral data generator 28 includes a product data retriever 29 arranged to retrieve product data from a product database 17. The product referral generator 28 generates the product referral data with respect to first external computing system 11A (that is, Facebook), by retrieving product data stored in a product database 17 and generating the product referral data using the product data. The product database 17 is implemented using Structured Query Language (SQL): a programming language designed for managing data. However, persons skilled in the art will appreciate that the product database 17 may be implemented using other programming languages. In the product database 17, the product data with respect to each one of the products comprises a description of the product (including a name of the product), a product price, and a link or hyperlink (for example, a uniform resource locator (URL) or a web address) to the retail website where the product is available for purchase. It is envisaged that the product data may also include additional information such as the retailer identifier corresponding to the retail computing system 15 providing the retail website. Persons skilled in the art will appreciate that the product referral data generated with respect to the first external computing system 11A may be different or the same when compared to the product referral data generated with respect to the second external computing system 11B.

Another one of the components of the system 18 is a product referral adder 27. The product referral adder 27 is arranged to access the first external computing system 11A (that is, to access Facebook) and the second external computing system 11B (that is, to access Twitter) using the external user identifiers (that is, the Facebook username and the Facebook password corresponding to the Facebook username, and the Twitter username and the Twitter password corresponding to the Twitter username) retrieved by the external user identifier retriever 25 to add the product referral data with respect to the first external computing system 11A to the first external database 12A, and to add the product referral data with respect to the second computing system 11B to the second external database 12B.

The product referral data added to the external databases 12 enables (i) the first external computing system 11A to generate a message (for example, a timeline post, a chat message etc) on Facebook, and (ii) the second external computing system 11B to generate a tweet on Twitter, each one of the message and tweet comprising a tracking link to the retail website. A user operating a user computing device 13B can follow the tracking link to the retail website. A program script written in JavaScript is executed when the user follows the tracking link to the retail website using the user computing device 13B. A querystring comprising user identification data associated with the user identifier received by the user identifier receiver 23 is transmitted from the user computing device 13B to the system 18 when the program script is executed. The user identification data is generated by the user computing device 13B based on the product referral data, and is arranged to enable an identification of the user identifier received by the user identifier receiver 23.

It is envisaged that an alternative embodiment may include a user identification data transceiver in the retail computing system 15 that is arranged to receive the user identification data from the user identifier receiver 23, and to forward the user identification data to the system 18 only upon a user completing a purchase of the product corresponding to the product identifier received by the product identifier receiver 23. In such an alternative embodiment, the product referral data may be arranged such that the user identification data is initially transmitted to the retail computing system 15, which subsequently transmits the user identification data only when the user completes the purchase of the product on a purchase confirmation page of the retail website.

The system 18 also comprises a user identification data receiver 26 arranged to receive user identification data transmitted from the user computing device 13B to the system 18. Also, the system 18 comprises a prize awarder 24 arranged to award a prize corresponding to the award value transmitted in the querystring from the user computing device 13A to the product identifier receiver 23 upon the user identification data receiver 23 receiving the user identification data transmitted from the user computing device 13B to the system 18. It is envisaged that, in an alternative embodiment, the prize awarder 24 may be arranged not to award a prize immediately upon the user identification data receiver 23 receiving the user identification data. For example, in an alternative embodiment, upon the user identification data receiver 23 receiving the user identification data, the user identification data receiver 26 may increment a user counter associated with the user identifier received by the user identifier receiver 21 in the user database 19, and the prize awarder 24 may make an award only upon the user counter reaching a predetermined value.

Each one of the user computing devices 13 comprises a user input device—such as a keyboard, a touchscreen, a mouse or a keyboard and a mouse—that allows the user computing device 13 to receive user input (such as the user identifier) from a user. Also, each one of the user computing devices 13 comprises an output device—such as a display—for outputting information (such as displaying the message generated by the external computing device 11 using the product referral data generated by the product referral data generator 28).

It is envisaged that an alternative embodiment of the system 18 is adapted to refer products available for purchase from a plurality of retail websites. Also, it is envisaged that an alternative embodiment of the product referral system is adapted to refer products to other social networking systems. Examples of such systems include MySpace (trade mark) and LinkedIn (trade mark). Also, it is envisaged that the program scripts may be implemented using programming other than JavaScript. For example, the program scripts may alternatively or additionally be implemented using PHP, Ajax, jQuery etc.

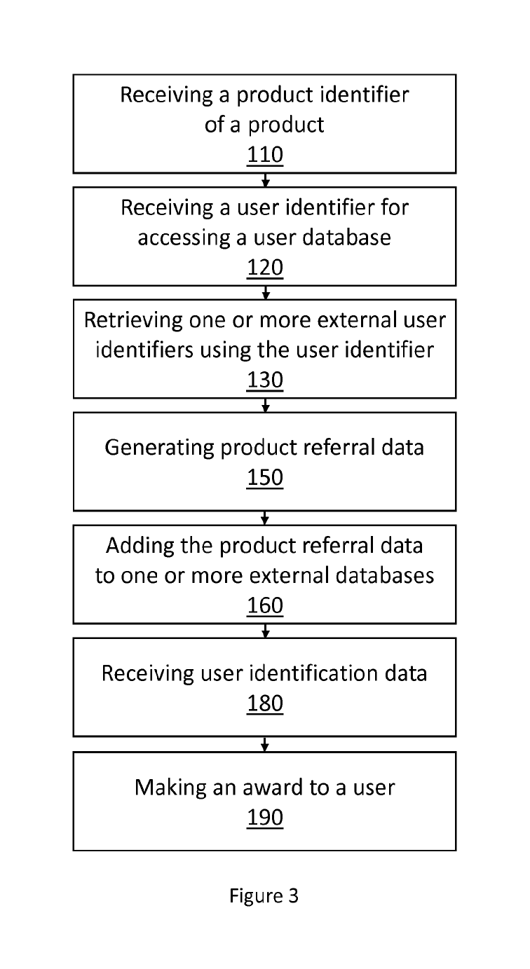

FIG. 3 is a flow chart of an embodiment of the method of enabling a referral of a product, carried out using the system of FIGS. 1 and 2.

At step 110, a product identifier of a product from the retail computing system 15 is received by the product identifier receiver 23 of the system 18. At step 120, a user identifier from the first computing device 13A is received by the user identifier receiver 21. At step 130, the external user identifier retriever 25 retrieves one or more external user identifiers from the user database 19 automatically using the received user identifier. At step 150, product referral data is automatically generated by the product referral data generator 28 with respect to each one of the first external computing system 11A and the second external computing system 11B using the received product identifier. As discussed above, product data is retrieved by the product data retriever 29 of the product referral data generator 28 to generate the product referral data with respect to the first external computing system 11A.

At step 160, the system 18 accesses the first external computing system 11A and the second computing system 11B using the retrieved external user identifiers to add the product referral data generated with respect to the first external computing system 11A to the first external database 12A, and to add the product referral data generated with respect to the second external computing system 11B to the second external database 12B. At step 180, user identification data is received by the user identification data receiver 26 in response to a user following a tracking link of a message on Facebook generated by the first external computing system 11A using the product referral data added to the external database 12A. At step 190, in response to receiving the user identification data, an award is made by the prize awarder 24 to the user.

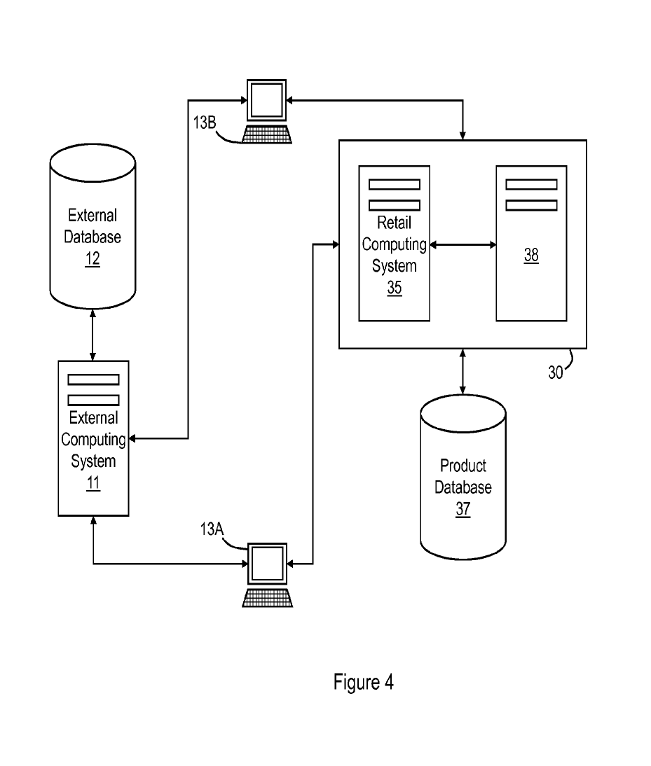

Referring to FIGS. 4 to 6 of the drawings, there is shown another embodiment of a system for enabling a referral of a product. The system generates product referral data for retrieval by a first user computing device. The product referral data once retrieved by the first user computing device is for addition to an external database in data communication with the external computing system, by accessing the external computing system using a nominated user identifier of a user. The product referral data once added to the external database is for retrieval by a second user computing device. The product referral data once retrieved by the second user computing device is for generation of user identification data corresponding to the nominated user identifier. The user identification data once generated is received by the system. The system is advantageous in that it enables positive outcomes of referrals to be tracked.

FIG. 4 is a schematic diagram of the physical architecture of another embodiment of the system for enabling a referral of a product 38. In this embodiment, a single combined computing device 30 is used to implement the system 38 and a retail computing system 35.

The combined computing system 30 provides a retail website. Products are available for purchase on the retail website. The combined computing system 30 is connected to an external computing system 11 providing a social networking service and website Facebook. The external computing system 11 is connected to an external database 12 storing data of users of Facebook. It is envisaged that the combined computing system 30 may be connected to more than one external computing system. In particular, it is envisaged that the combined computing system 30 may additionally be connected to another external computing system providing a referral website providing links for referring products from different retail websites.

A first user computing device 13A is connected to the combined computing system 30 and the external computing system 11. A user of the combined computing system 30 can access the combined computing system 30 using the first user computing device 13A. The user can also access the external computing system 11 using the first user computing device 13A. In particular, the external computing system 11 can be accessed by inputting an external user identifier in the form of a Facebook username and a Facebook password corresponding to the Facebook username.

The combined computing system 30 and the external computing system 11 are also connected to a second user computing device 13B. A user of Facebook (a Facebook friend) can access the external computing system 11 using the second user computing device 13B. The Facebook friend is linked to the user of the combined computing system 30 such that messages—such as status updates, comments, photos, links etc—added by the user of the system 18 to Facebook can be viewed by the Facebook friend.

The combined computing system 30 is connected to a product database 37 storing product data with respect to each one of the products available for purchase on the retail website provided by the combined computing system 30. The product data with respect to each product is added to the product database 37 by a retailer.

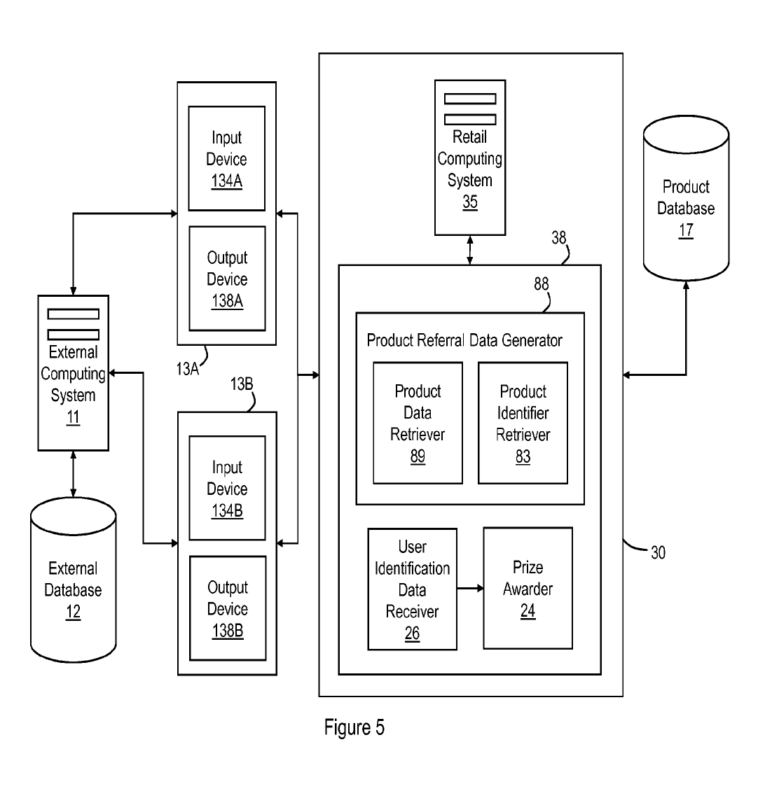

FIG. 5 is a schematic diagram of the functional components of the system for enabling a referral of a product 38 of FIG. 4. As mentioned above, the functional components are typically implemented by a processor of the system 38 executing program code and data stored in a memory of the system 38. However, persons skilled in the art will appreciate that one or more of the components could be implemented in an alternative manner, such as a dedicated circuit.

One of the functional components is a product referral data generator 88 arranged to generate product referral data for the retail website provided by the retail computing system 35. The product referral data generator 88 comprises a product identifier retriever 83 arranged to retrieve a product identifier of the product from a product database 37. The product referral data generator 88 also comprises a product data retriever 89 arranged to retrieve product data with respect to the product from the product database 37. In this embodiment, the product data retrieved by the product data retriever 89 includes an award value with respect to the product. However, it is envisaged that the product data retrieved by the product data retriever 89 may include other data such a URL with respect to the product. The product referral data is generated by the product referral data generator 88 based on using the retrieved product identifier and the retrieved product data. In this embodiment, the generated product referral data comprises both the product identifier retrieved by the product identifier retriever 83 and the product data retrieved by the product data retriever 89. However, it is envisaged that the product referral data may not include both the product identifier retrieved by the product identifier retriever 83 and the product data retrieved by the product data retriever 89. For example, the generated product referral data may comprise only the product identifier retrieved by the product identifier retriever 83.

The product referral data is with respect to a product available for purchase on the retail website. The product referral data is arranged to be provided in a link on the retail website with respect to the product. The product referral data is retrieved by the first user computing device 13A when a first user views the retail website. A program script written in JavaScript is executed when the first user clicks on the link. In particular, when the first user clicks on the link on the first user computing device 13A, a first querystring is transmitted from the first user computing device 13A to the external computing system 11 when the program script is executed. The first querystring includes the product referral data, the product identifier, a nominated user identifier of the first user, and the award value. In this embodiment, the nominated user identifier is an external user identifier in the form of a Facebook username and a Facebook password corresponding to the Facebook username. Upon receiving the first querystring from the first user computing device 13A, the external computing system 11 is accessed using the external user identifier in the first querystring, and the product referral data is added to the external database 12 in data communication with the external computing system 11.

The product referral data added to the external database 12 is arranged to enable generation of a Facebook message. In particular, when a second user accesses Facebook using the second user computing device 13B, message data comprising the product referral data and corresponding to the Facebook message is generated by the external computing system 11 based on the product referral data added to the external database 12. The generated message data is then retrieved by the second user computing device 13B. The Facebook message is then displayed on the display 138B of the second user computing device 13B. The message comprises a user tracking link to the retail website. A second program script written in JavaScript is executed when the second user clicks on the tracking link in the message. Upon execution of the second program script, a second querystring comprising user identification data and the award value previously transmitted from the first user computing device 13A to the external computing system 11 is generated by the second user computing device 13B. The user identification data corresponds to the external user identifier previously transmitted in the first querystring from the first user computing device 13A to the external computing system 11, and is generated by the second user computing device 13B based on the product referral data. After the second querystring is generated, the second querystring is transmitted from the second user computing device 13B to the system 38.

The system 38 comprises a user identification data receiver 86 arranged to receive the second querystring including the user identification data corresponding to the external user identifier previously transmitted in the first querystring from the first user computing device 13A to the external computing system 11. In this embodiment, the user identification data receiver 86 is arranged to receive the user identification data directly from the second user computing device 13B. However, it is envisaged that the user identification data receiver 86 may alternatively receive the user identification data from the retail computing system 35 after the retail computing system 35 receives the second querystring from the second user computing device 13B.

The system 38 also comprises a prize awarder 84 arranged to, in response to the user identification data receiver 86 receiving the user identification data transmitted from the second user computing device 13B to the system 38, make an award corresponding to the award value transmitted in the first querystring from the first user computing device 13A to the product identifier retriever 83 at step 290. The award is made to the external user identifier corresponding to the user identification data. As mentioned above, it is envisaged that, in an alternative embodiment, the prize awarder 24 may be arranged not to award a prize immediately upon the user identification data receiver 23 receiving the user identification data, and the prize awarder 24 may make an award only upon a user counter reaching a predetermined value.

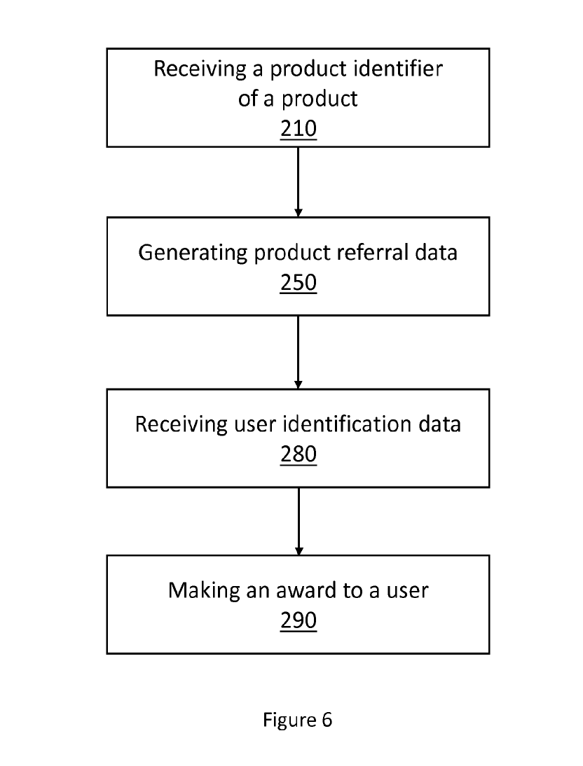

FIG. 6 is a flow chart of an alternative embodiment of the method of enabling a referral of a product, carried out using the system 38 of FIGS. 4 and 5.

Upon receiving a request from a first user operating the first user computing device 13A, the retail computing system 35 of the system 38 generates a retail website and transmit the retail website to the first user computing device 13A for display to the first user on the display 138A of the first user computing device 13A. The generation of the website involves the product identifier retriever 83 of the system 38 retrieving a product identifier of the product from the product database 17 at step 210, and the product referral data generator 88 of the system 38 generating product referral data using the retrieved product identifier at step 250.

The product referral data retrieved by the first user computing device 13A is added to the external database 12 in data communication with the external computing system 11. The product referral data is added by accessing the external computing system using an external user identifier of the first user. When a second user operating the second user computing device 13B accesses the external computing system 11, the product referral data added to the external database is used by the external computing system 11 to generate message data, and the message data is retrieved by the second user computing device 13B. The product referral data retrieved by the second user computing device 13B for generation of a Facebook message or post comprising a user tracking link. When the second user clicks on the link, user identification data corresponding to the external user identifier (that is, the external user identifier previously transmitted in the first querystring from the first user computing device 13A to the external computing system 11) is generated by the second computing device 13B and transmitted from the second user computing device 13B to the system 30.

At step 280, the user identification data receiver 86 of the system 30 receives from the second user computing device 13B the user identification data corresponding to the external user identifier previously used by the first user computing device 13A to access the external computing system 11.

At step 290, in response to the user identification data receiver 86 receiving the user identification data, the prize awarder 84 makes an award to the first user.

Further aspects of the method will be apparent from the above description of the system. For example, it will be appreciated that the retail website provided by the retail computing system may alternatively be a mobile application (such as a smartphone app). Persons skilled in the art will also appreciate that the method could be embodied in program code. The program code could be supplied in a number of ways, for example on a tangible computer readable medium, such as a disc or a memory (for example, that could replace part of memory) or as a data signal (for example, by transmitting it from a server).

Similarly, it will be appreciated that the data in the product database and the user database can be supplied on any appropriate tangible data carrier, such as by writing them to a portable device (such as a USB drive), storing them in a memory (including transmitting identifiers to a device having a memory) etc.

Modifications within the scope of the invention may be readily effected by those skilled in the art. It is to be understood, therefore, that this invention is not limited to the particular embodiments described by way of example hereinabove.

In the claims that follow and in the preceding description of the invention, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference made herein to prior art is not intended to imply that such prior art forms or formed a part of the common general knowledge in Australia or any other country.

1. A system for enabling a referral of a product, comprising:
a product identifier retriever arranged to retrieve from a product database a product identifier of a product;
a product referral data generator arranged to generate product referral data with respect to an external computing system using the retrieved product identifier, wherein
(i) the generated product referral data is for retrieval by a first user computing device in data communication with the external computing system, the product referral data once retrieved by the first user computing device being for addition to an external database in data communication with the external computing system, by accessing the external computing system using a nominated user identifier of a user, and
(ii) the product referral data once added to the external database is for retrieval by a second user computing device in data communication with the external computing system, the product referral data once retrieved by the second user computing device being for generation of user identification data corresponding to the nominated user identifier; and
a user identification data receiver arranged to:
receive the user identification data corresponding to the nominated user identifier; and
make an award to the user corresponding to the nominated user identifier.

2. A system as claimed in claim 1, wherein the first user computing device and the second user computing device are provided by the same computing device.

3. A system as claimed in claim 1 or 2, wherein the product referral data once added to the external database enables a message to be generated on a website provided by the external computing system.

4. A system as claimed in claim 3, wherein the message comprises a link to a retail website provided by a retail computing system.

5. A system as claimed in claim 3 or 4, wherein the message comprises a user tracking link for enabling the generation of the user identification data.

6. A system as claimed in claim 5, wherein the received user identification data is received from the second user computing device upon a user following the user tracking link using the second user computing device.

7. A system as claimed in claim 5, wherein the received user identification data is received from the retail computing device upon a user following a link to a purchase webpage of the retail website.

8. A system as claimed in any one of claims 1 to 7, wherein the award corresponds to an award value corresponding to the product.

9. A system as claimed in any one of claims 1 to 7, wherein a user counter is incremented in response to receipt of the user identification data.

10. A system as claimed in claim 9, wherein the user counter is stored in a user database.

11. A system as claimed in claim 10, wherein the user identification data receiver is arranged to monitor the user counter.

12. A system as claimed in claim 11, wherein the user identification data receiver is arranged to make the award in response to the user counter reaching a predetermined value.

13. A computer-implemented method of enabling a referral of a product, comprising:
retrieving from a product database a product identifier of a product;
generating product referral data with respect to an external computing system using the retrieved product identifier, wherein
(i) the generated product referral data is for retrieval by a first user computing device in data communication with the external computing system, the product referral data once retrieved by the first user computing device being for addition to an external database in data communication with the external computing system, by accessing the external computing system using a nominated user identifier of a user, and
(ii) the product referral data once added to the external database is for retrieval by a second user computing device in data communication with the external computing system, the product referral data once retrieved by the second user computing device being for generation of user identification data corresponding to the nominated user identifier; and
receiving the user identification data corresponding to the nominated user identifier; and
making an award to the user corresponding to the nominated user identifier.

14. A method as claimed in claim 13, wherein the first user computing device and the second user computing device are provided by the same computing device.

15. A method as claimed in claim 13 or 14, wherein the product referral data once added to the external database enables a message to be generated on a website provided by the external computing system.

16. A method as claimed in claim 15, wherein the message comprises a link to a retail website provided by a retail computing system.

17. A method as claimed in claim 15 or 16, wherein the message comprises a user tracking link for enabling the generation of the user identification data.

18. A method as claimed in claim 17, wherein the received user identification data is received from the second user computing device upon a user following the user tracking link using the second user computing device.

19. A method as claimed in claim 17, wherein the received user identification data is received from the retail computing device upon a user following a link to a purchase webpage of the retail website.

20. A method as claimed in any one of claims 13 to 19, wherein the award corresponds to an award value corresponding to the product.

21. A method as claimed in any one of claims 13 to 19, further comprising incrementing a user counter in response to receipt of the user identification data.

22. A method as claimed in claim 21, wherein the user counter is stored in a user database.

23. A method as claimed in claim 22, further comprising monitoring the user counter.

24. A method as claimed in claim 23, wherein the award is made in response to the user counter reaching a predetermined value.

25. A system for enabling a referral of a product, comprising:
a product identifier retriever arranged to retrieve from a product database a product identifier of a product available for purchase on a retail website provided by a retail computing system;
a product referral data generator arranged to generate product referral data with respect to an external computing system using the retrieved product identifier, wherein
(i) the generated product referral data is for retrieval by a first user computing device in data communication with the external computing system, the product referral data once retrieved by the first user computing device being for addition to an external database in data communication with the external computing system, by accessing the external computing system using a nominated user identifier of a user,
(ii) the product referral data once added to the external database is for generation of message data for retrieval by a second user computing device in data communication with the external computing system and the retail computing system, the product referral data once retrieved by the second user computing device being for generation of a message comprising a user tracking link for generating user identification data corresponding to the nominated user identifier, and
(iii) the user identification data once generated by the second computing device being for transmission from the second user computing device to the system or the retail computing system; and
a user identification data receiver arranged to:
receive from the second user computing device or the retail computing system the user identification data corresponding to the nominated user identifier; and
make an award to the user corresponding to the nominated user identifier.

26. A system for enabling a referral of a product, comprising:
a product identifier receiver arranged to receive a product identifier of the product from a retail computing system;
a user identifier receiver arranged to receive a user identifier for accessing a user database storing a plurality of external user identifiers, each external user identifier being associated with a respective one of a plurality of user identifiers in the user database;
an external user identifier retriever arranged to retrieve one or more external user identifiers from the user database using the received user identifier;
a product referral data generator arranged to generate product referral data with respect to each one of one or more external computing systems in data communication with respective external databases, using the received product identifier; and
a product referral adder arranged to access the external computing systems using respective retrieved external user identifiers to add the generated product referral data to respective external databases of the external computing systems.

27. A system as claimed in claim 26, wherein the product is a good, a service, or a good and a service.

28. A system as claimed in claim 26 or 27, wherein the product identifier comprises a retailer identifier and an award value.

29. A system as claimed in any one of claims 26 to 28, wherein the retail computing system is or provides a retail website.

30. A system as claimed in claim 29, wherein the product identifier is transmitted from the retail computing system to the product identifier receiver upon a user following a link on the retail website.

31. A system as claimed in any one of claims 26 to 30, wherein the product referral data comprises product data retrieved by a product data retriever from a product database using the received product identifier.

32. A system as claimed in claim 31, wherein the product data comprises a description of the product and a product price.

33. A system as claimed in claim 31 or 32, wherein the product data comprises a link to the retail website.

34. A system as claimed in any one of claims 30 to 33, wherein each external computing system is or provides a social networking website, and each retrieved external user identifier is a social networking website username for accessing the social networking website provided by the external computing system.

35. A system as claimed in claim 34, wherein the product referral data enables a message to be generated on the social networking website provided by the external computing system.

36. A system as claimed in claim 35, wherein the message comprises the link to the retail website of the product data.

37. A system as claimed in claim 36, wherein the message comprises a user tracking link comprising user identification data for identifying the received user identifier.

38. A system as claimed in claim 37, wherein the user identification data is arranged to be transmitted to the system upon a user following the user tracking link.

39. A system as claimed in claim 37, wherein the user identification data is arranged to be transmitted to the system upon a user following a link to a purchase webpage of the retail website.

40. A system as claimed in claim 38 or 39, further comprising a user identification data receiver arranged to receive the user identification data transmitted to the system.

41. A system as claimed in any one of claims 38 to 40, wherein the user identification data receiver is arranged to make an award in response to receiving the transmitted user identification data.

42. A system as claimed in claim 41, wherein the award corresponds to the award value.

43. A system as claimed in any one of claims 40 to 42, wherein the user identification data receiver is arranged to increment a user counter in response to receiving the transmitted user identification data.

44. A system as claimed in claim 43, wherein the user counter is stored in the user database.

45. A system as claimed in claim 44, wherein the user identification data receiver is arranged to monitor the user counter.

46. A system as claimed in claim 45, wherein the user identification data receiver is arranged to make an award in response to the user counter reaching a predetermined value.

47. A system as claimed in any one of claims 26 to 46, wherein the user identifier is received by the user identifier receiver from a first user device and the user identification data is received by the user identification data receiver from a second user device.

48. A system as claimed in any one of claims 26 to 47, further comprising the user database.

49. A system as claimed in any one of claims 31 to 48, further comprising the product database.

50. A computer-implemented method of enabling a referral of a product, comprising:
receiving a product identifier of the product from a retail computing system;
receiving a user identifier for accessing a user database storing a plurality of external user identifiers, each external user identifier being associated with a respective one of a plurality of user identifiers in the user database;
retrieving one or more external user identifiers from the user database using the received user identifier;
generating product referral data with respect to each one of one or more external computing systems in data communication with respective external databases, each product referral data corresponding to the received product identifier; and
accessing the external computing systems using respective retrieved external user identifiers to add respective product referral data to respective external databases of the external computing systems.

51. A method as claimed in claim 50, wherein the product is a good, a service, or a good and a service.

52. A method as claimed in claim 50 or 51, wherein the product identifier comprises a retailer identifier and an award value.

53. A method as claimed in any one of claims 50 to 52, wherein the retail computing system is or provides a retail website.

54. A method as claimed in claim 53, wherein the product identifier is transmitted from the retail computing system to the product identifier receiver upon a user following a link on the retail website.

55. A method as claimed in any one of claims 50 to 54, wherein the product referral data comprises product data retrieved by a product data retriever from a product database using the received product identifier.

56. A method as claimed in claim 55, wherein the product data comprises a description of the product and a product price.

57. A method as claimed in claim 51 or 56, wherein the product data comprises a link to the retail website.

58. A method as claimed in any one of claims 50 to 57, wherein each external computing system is or provides a social networking website, and each retrieved external user identifier is a social networking website username for accessing the social networking website provided by the external computing system.

59. A method as claimed in claim 58, wherein the product referral data enables a message to be generated on the social networking website provided by the external computing system.

60. A method as claimed in claim 59, wherein the message comprises the link to the retail website of the product data.

61. A method as claimed in claim 60, wherein the message comprises a user tracking link for enabling generation of user identification data for identifying the received user identifier.

62. A method as claimed in claim 61, wherein the user identification data is arranged to be transmitted to the system upon a user following the user tracking link.

63. A method as claimed in claim 61, wherein the user identification data is arranged to be transmitted to the system upon a user following a link to a purchase webpage of the retail website.

64. A method as claimed in any one of claims 50 to 63, further comprising:
receiving user identification data transmitted in response to a user following a link of a message generated using the product referral data added to one of the external databases; and
making an award in response to receiving the user identification data.

65. A method as claimed in claim 64, wherein the award corresponds to the award value.

66. A method as claimed in any one of claims 64 to 65, further comprising incrementing a user counter in response to receiving the transmitted user identification data.

67. A method as claimed in claim 66, wherein the user counter is stored in the user database.

68. A method as claimed in claim 67, wherein the user identification data receiver is arranged to monitor the user counter.

69. A method as claimed in claim 68, wherein the user identification data receiver is arranged to make an award in response to the user counter reaching a predetermined value.

70. A method as claimed in any one of claims 50 to 69, wherein the user identifier is received by the user identifier receiver from a first user device and the user identification data is received by the user identification data receiver from a second user device.

71. A system enabling a referral of a product, substantially as herein described with reference to the accompanying drawings.

72. A method of enabling a referral of a product, substantially as herein described with reference to the accompanying drawings.
